(19) United States
(12) Patent Application Publication
(10) Pub. No.: US 2013/0083162 A1
(43) Pub. Date: Apr. 4, 2013

(54) DEPTH FUSION METHOD AND APPARATUS USING THE SAME

(71) Applicants: Chun Wang, Shanghai City (CN); Guang-Zhi Liu, Shanghai City (CN); Jian-De Jiang, Shaanxi Province (CN)

(72) Inventors: Chun Wang, Shanghai City (CN); Guang-Zhi Liu, Shanghai City (CN); Jian-De Jiang, Shaanxi Province (CN)

(73) Assignee: NOVATEK MICROELECTRONICS CORP., Hsinchu (TW)

(21) Appl. No.: 13/372,450

(22) Filed: Feb. 13, 2012

(30) Foreign Application Priority Data
Sep. 30, 2011 (CN) 201110300094.0

(51) Int. Cl. H04N 13/00

(52) U.S. Cl. 348/43; 348/E13.062

(57) ABSTRACT

A depth fusion method adapted for a 2D-to-3D conversion image processing apparatus is provided. The depth fusion method includes the following steps. Respective motion-based depths of a plurality of blocks in an image frame are obtained. An original image-based depth of each of the blocks is obtained. The original image-based depth of each of the blocks is converted to obtain a converted image-based depth of each of the blocks. The motion-based depth and the converted image-based depth of each of the blocks are fused block by block to obtain a fusion depth of each of the blocks. Furthermore, a depth fusion apparatus is also provided.

### CROSS-REFERENCE TO RELATED APPLICATION

This application claims the priority benefit of China application serial no. 201110300094.0, filed Sep. 30, 2011. The entirety of the above-mentioned patent application is hereby incorporated by reference herein and made a part of this specification.

### BACKGROUND OF THE INVENTION

1. Field of the Invention

The invention generally relates to an image processing method and an apparatus using the same, in particular, to a depth fusion method adapted for a 2D-to-3D conversion image processing apparatus and an apparatus using the same.

2. Description of Related Art

Along with the progress of the display technology, displays capable of providing 3D image frames emerge rapidly. Image information required by such a 3D display includes 2D image frames and depth information thereof. By using the 2D image frames and the depth information thereof, the 3D display can reconstruct corresponding 3D image frames. Therefore, how to obtain the depth information of the 2D image frames becomes an important subject.

Generally speaking, depth information of image frames may be obtained by calculating changes of a moving object in the image frames. In the prior art, fusion depths may be obtained by using motion and pictorial depth cues, in which a weight when each depth is generated is globally changed according to analysis on camera motion. According to the above concept, the prior art provides various depth fusion methods; however, the following problems may be generated.

In the prior art, fusion depths may be obtained by using a method through image-based depths and consciousness-based depths. However, in this manner, when a camera motion occurs, the obtained fusion depths may not be correct. In another aspect, a method for analyzing a moving object in a frame through motion based segmentation is proposed, in which a region capable of being segmented is defined by using a group of consistent actions and position parameters, so as to analyze the moving object. The object region obtained through analysis by using the motion based segmentation method is relatively complete; however, if the manner for segmenting the region in the depth fusion method through image-based depth or consciousness-based depth is different from the motion based segmentation, the depth in the region of the moving object might be segmented into a plurality of parts incorrectly.

### SUMMARY OF THE INVENTION

The disclosure is directed o a depth fusion method, which is capable of effectively generating a fusion depth of each block in an image frame.

The disclosure is further directed to a depth fusion apparatus, which uses the depth fusion method, and is capable of effectively generating a fusion depth of each block in an image frame.

In an aspect, a depth fusion method is provided, which is adapted for a 2D-to-3D conversion image processing apparatus. The depth fusion method includes the following steps. Respective motion-based depths of a plurality of blocks in an image frame are obtained. An original image-based depth of each of the blocks is obtained. The original image-based depth of each of the blocks is converted to obtain a converted image-based depth of each of the blocks. The motion-based depth and the converted image-based depth of each of the blocks are fused block by block to obtain a fusion depth of each of the blocks.

In an embodiment of the invention, the step of converting the original image-based depth of each of the blocks to obtain the converted image-based depth of each of the blocks is performed according to a difference between a local motion vector of each of the blocks and a global motion vector of the image frame.

In an embodiment of the invention, the step of obtaining the motion-based depths of the blocks includes the following steps. A Local motion vector of each of the blocks is obtained. A global motion vector of the image frame is calculated according to the local motion vectors of the blocks. A motion difference between the local motion vector of each of the blocks and the global motion vector is calculated, so as to generate a plurality of relative motion vectors. The motion-based depth of each of the blocks is obtained according to the relative motion vectors.

In an embodiment of the invention, the step of converting the original image-based depth of each of the blocks to obtain the converted image-based depth of each of the blocks includes the following steps. A conversion parameter of each of the blocks is determined according to the relative motion vector of each of the blocks. The conversion parameter of each of the blocks is used to convert the original image-based depth of the block into the converted image-based depth.

In an embodiment of the invention, the step of using the conversion parameter of each of the blocks to convert the original image-based depth of the block into the converted image-based depth includes the following steps. A maximum one of the original image-based depth of each of the blocks with the conversion parameter greater than a threshold is obtained to serve as a maximum image-based depth. The converted image-based depth of each of the blocks is calculated according to the conversion parameter of each of the blocks, the original image-based depth of each of the blocks, and the maximum image-based depth of the image frame.

In an embodiment of the invention, the depth fusion method calculates the converted image-based depth by using the following formula: Di′=alpha_blk* k*Dimax+(1−alpha_blk)*Di, where Di is the original image-based depth, Di′ is the converted image-based depth, alpha_blk is the conversion parameter, k is an adjustment parameter, and 0<k≦1.

In an embodiment of the invention, the step of obtaining the original image-based depth of each of the blocks includes determining the original image-based depth of each of the blocks according to image-based depth cues information of each of the blocks and consciousness-based depth cues information of the image frame.

In another aspect, a depth fusion apparatus is provided, which is adapted for a 2D-to-3D conversion image processing apparatus. The depth fusion apparatus includes a motion-based depth capture unit, an image-based depth capture unit, and a depth fusion unit. The motion-based depth capture unit obtains respective motion-based depths of a plurality of blocks in an image frame. The image-based depth capture unit obtains an original image-based depth of each of the blocks, and converts the original image-based depth of each of the blocks to obtain a converted image-based depth of each of the blocks. The depth fusion unit fuses, block by block, the motion-based depth and the converted image-based depth of each of the blocks to obtain a fusion depth of each of the blocks.

In an embodiment of the invention, the image-based depth capture unit converts the original image-based depth of each of the blocks according to a difference between a local motion vector of each of the blocks and a global motion vector of the image frame, so as to obtain the converted image-based depth of each of the blocks.

In an embodiment of the invention, the motion-based depth capture unit includes a motion estimation unit and a motion-based depth generation unit. The motion estimation unit obtains a local motion vector of each of the blocks, and calculates a global motion vector of the image frame according to the local motion vector of each of the blocks. The motion estimation unit calculates a motion difference between the local motion vector of each of the blocks and the global motion vector, so as to generate a plurality of relative motion vectors. The motion-based depth generation unit obtains the motion-based depth of each of the blocks according to the relative motion vectors.

In an embodiment of the invention, the image-based depth capture unit includes an image-based depth conversion unit. The image-based depth conversion unit determines a conversion parameter of each of the blocks according to the relative motion vector of each of the blocks. The image-based depth conversion unit uses the conversion parameter of each of the blocks to convert the original image-based depth of the block into the converted image-based depth.

In an embodiment of the invention, the image-based depth conversion unit obtains a maximum one of the original image-based depth of each of the blocks with the conversion parameter greater than a threshold to serve as a maximum image-based depth. The image-based depth conversion unit calculates the converted image-based depth of each of the blocks according to the conversion parameter of each of the blocks, the original image-based depth of each of the blocks, and the maximum image-based depth of the image frame.

In an embodiment of the invention, the image-based depth conversion unit calculates the converted image-based depth according to the following formula: Di′=alpha_blk*k*Dimax+(1−alpha_blk)*Di, where Di is the original image-based depth, Di′ is the converted image-based depth, alpha_blk is the conversion parameter, k is an adjustment parameter, and 0<k≦1.

In an embodiment of the invention, the image-based depth capture unit includes an image-based depth obtaining unit. The image-based depth obtaining unit determines the original image-based depth of each of the blocks according to image-based depth cues information of each of the blocks and consciousness-based depth cues information of the image frame.

Based on the above, in the exemplary embodiments of the invention, before depth fusion, the method converts the original image-based depths, and fuses, block by block, the motion-based depths and the converted image-based depths of the blocks, thereby effectively generating the fusion depths of the blocks of the image frame.

In order to make the aforementioned features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a depth fusion apparatus according to an embodiment of the invention.

FIG. 2 is a flow chart of steps of a depth fusion method according to an embodiment of the invention.

FIG. 3 is a flow chart of steps of a method for obtaining motion-based depths Dm according to an embodiment of the invention.

FIG. 4 is a flow chart of steps of a method for obtaining converted image-based depths Di′ according to an embodiment of the invention.

FIG. 5 shows a curve mapping relationship between conversion parameters alpha_blk and relative motion vectors ∥MV−MV_cam∥ according to an embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

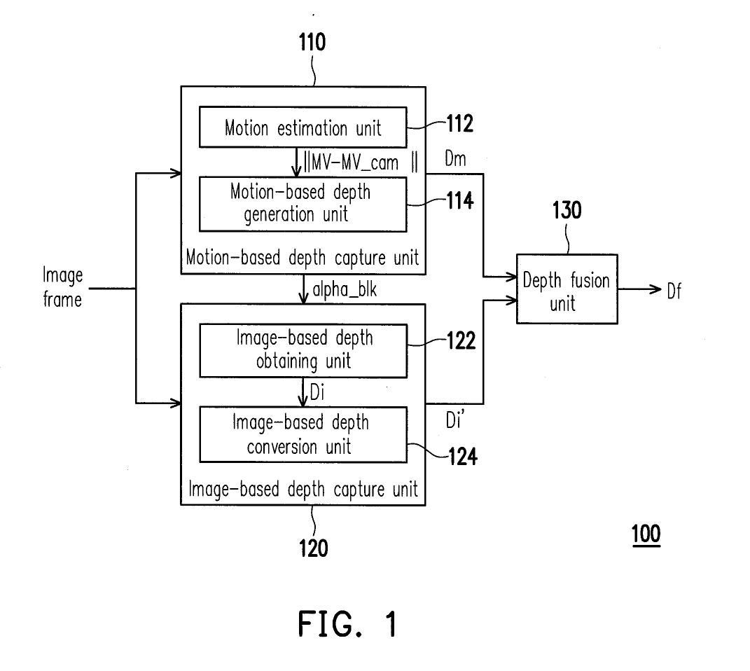

FIG. 1 is a schematic block diagram of a depth fusion apparatus according to an embodiment of the invention. Referring to FIG. 1, a depth fusion apparatus 100 in this embodiment is adapted for a 2D-to-3D conversion image processing apparatus (not shown), and is at least used for generating a fusion depth Df of each block in an image frame by using a depth fusion method provided in an exemplary embodiments of the invention. Therefore, the 2D-to-3D conversion image processing apparatus may reconstruct a corresponding 3D image frame according to a 2D image frame and depth information after fusion.

In this embodiment, the depth fusion apparatus 100 includes a motion-based depth (or referred to as depth from motion) capture unit 110, an image-based depth capture unit 120, and a depth fusion unit 130. Here, the motion-based depth capture unit 110 includes a motion estimation unit 112 and a motion-based depth generation unit 114. Similarly, the image-based depth (or referred to as depth from image) capture unit 120 includes an image-based depth obtaining unit 122 and an image-based depth conversion unit 124.

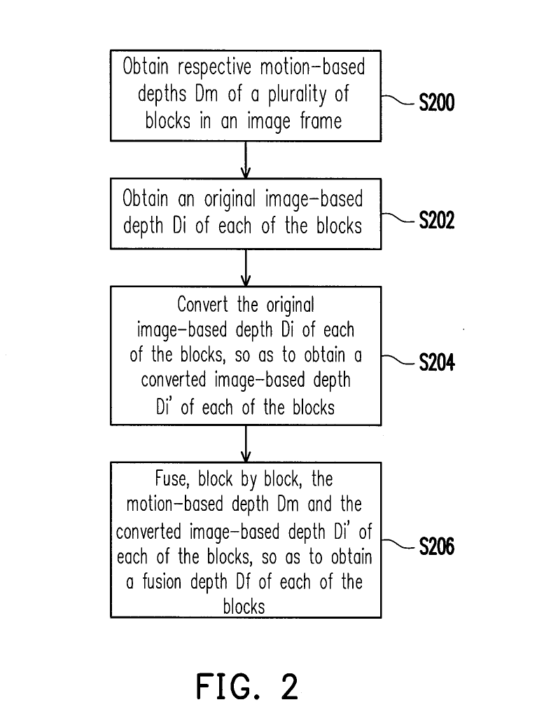

Specifically, FIG. 2 is a flow chart of steps of a depth fusion method according to an embodiment of the invention. Referring to FIG. 1 and FIG. 2, the depth fusion method of this embodiment is at least adapted for being executed by using the depth fusion apparatus 100 in FIG. 1, but the invention is not limited to this.

In Step S200, the motion-based depth capture unit 110 obtains a plurality of motion-based depths Dm in an image frame, and specifically, the motion-based depth capture unit 110 may obtain respective motion-based depths Dm of a plurality of blocks in the image frame in a manner such as motion estimation. Preferably, the motion-based depth Dm of each of the blocks is obtained according to a relative motion vector ∥MV−MV_cam∥ between a local motion vector MV of each of the blocks and a global motion vector MV_cam of the image frame, which will be illustrated in further detail later.

Then, in Step S202, the image-based depth obtaining unit 122 of the image-based depth capture unit 120 determines an original image-based depth Di of each of the blocks according to, for example, image-based depth cues information of each of the blocks and consciousness-based depth cues information of the image frame. It should be noted that, in this embodiment, there is no limitation on precedence for executing Step S200 of obtaining the motion-based depths Dm and Step S202 of obtaining the original image-based depths Di.

Thereafter, in Step S204, the image-based depth conversion unit 124 of the image-based depth capture unit 120 converts the original image-based depth Di of each of the blocks, so as to obtain a converted image-based depth Di′ of each of the blocks. In this embodiment, during the procedure of converting the original image-based depth Di of each of the blocks into the converted image-based depths Di′, a conversion parameter alpha_blk may be used, and the conversion parameter alpha_blk may be generated according to the relative motion vector ∥MV−MV_cam∥ of each of the blocks, which will be illustrated in further detail later.

After that, in Step S206, the depth fusion unit 130 fuses, block by block, the motion-based depth Dm and the converted image-based depth Di′ of each of the blocks, so as to obtain a fusion depth Df of each of the blocks. In this embodiment, the depth fusion unit 130 fuses the motion-based depth Dm and the converted image-based depth Di′ of each of the blocks, for example, according to the following Formula 1, so as to obtain the fusion depths Df:

Df=alpha_{—}m*Dm+alpha_{—}i*Di′ Formula 1.

In Formula 1, alpha_m and alpha_i respectively represent fusion parameters of the motion-based depth Dm and the converted image-based depth Di′. Preferably, in this embodiment, the fusion parameters alpha_m and alpha_i in Formula 1 may be set frame by frame according to different frame motions. For example, if the sequentially input image frame has a large motion, for the whole frame, the fusion parameter alpha_m may be set to a large value, and the fusion parameter alpha_i may be set to a small value. Relatively, if the sequentially input image frame tends to become static (that is, having a small motion), for the whole frame, the fusion parameter alpha_m may be set to a small value, and the fusion parameter alpha_i may be set to a large value. The motion of the image frame may be judged according to, for example, a total of the relative motion vector ∥MV−MV_cam∥ of each of the blocks in the frame.

In view of the above, in the depth fusion method of this embodiment, before the depth fusion, the original image-based depths Di are converted into converted image-based depths Di′, and the conversion parameters alpha_blk used during the procedure of conversion may take the relative motion vector ∥MV−MV_cam∥ of each of the blocks into consideration. Then, the motion-based depth Dm and the converted image-based depth Di′ of each of the blocks are fused block by block. As a result, with the fusion depth Df of each of the blocks of the image frame generated by using the depth fusion method, the integrity of the fusion depths Df in a specific moving object can be kept.

A method for obtaining the motion-based depth Dm of each of the blocks is illustrated below.

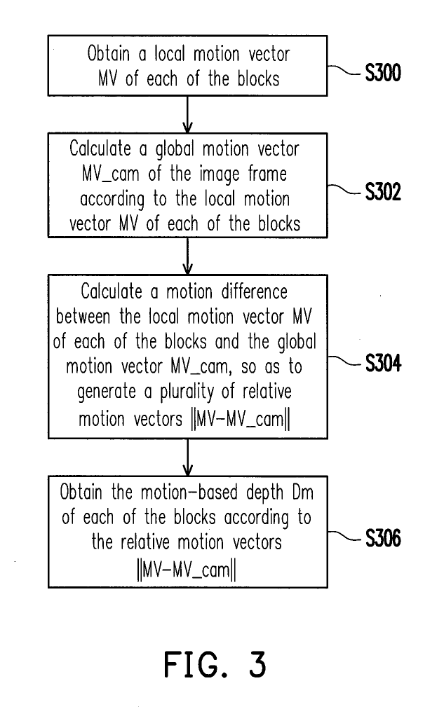

FIG. 3 is a flow chart of steps of a method for obtaining motion-based depths Dm according to an embodiment of the invention. Referring to FIG. 1 and FIG. 3, in this embodiment, the motion-based depth Dm of each of the blocks is obtained according to a relative motion vector ∥MV−MV_cam∥ between a local motion vector MV of each of the blocks and a global motion vector MV_cam of the image frame.

Specifically, in Step S300, the motion estimation unit 112 obtains a local motion vector MV of each of the blocks in a manner such as motion estimation. In

Step S302, the motion estimation unit 112 may calculate a global motion vector MV_cam of the image frame according to a plurality of local motion vectors MV. In an exemplary embodiment, a frame is divided into a central display region covering a centre of the frame, a peripheral display region enclosing the central display region, and a black edge region enclosing the peripheral display region, and the motion estimation unit 112 preferably calculates the global motion vector MV_cam merely according to the local motion vectors of the peripheral display region while excluding the central display region and the black edge region. More specifically, the peripheral display region may be further divided into a plurality of sub-regions overlapping or not overlapping each other. The motion estimation unit 112 may calculate an intra-region global motion belief and an inter-region global motion belief of each of the sub-regions according to the local motion vector of each of the sub-regions of the peripheral display region in the image frame, and determine the global motion vector MV_cam of the image frame accordingly. More details about the calculation of the global motion vector MV_cam may be obtained with reference to the description of, for example, PRC Application No. 201110274347.1.

Then, in Step S304, the motion estimation unit 112 calculates a motion difference between the local motion vector MV of each of the blocks and the global motion vector MV_cam, so as to generate a plurality of relative motion vectors ∥MV−MV_cam∥.

Thereafter, in Step S306, the motion-based depth generation unit 114 obtains the motion-based depth Dm of each of the blocks according to the relative motion vectors ∥MV−MV_cam∥. In this step, the motion-based depth generation unit 114 generates the motion-based depth Dm corresponding to each of the blocks by using, for example, a look-up table or a curve mapping relationship, but the invention is not limited to this. In this embodiment, the motion-based depth capture unit 110 uses the relative motion vectors ∥MV−MV_cam∥ to generate the motion-based depths Dm, thereby avoiding the influence of the camera motion on the motion-based depths Dm. More details about the calculation of the motion-based depths Dm may also be obtained with reference to the description of, for example, PRC Application No. 201110274347.1.

A method for obtaining a converted image-based depth Di′ of each of the blocks is illustrated below.

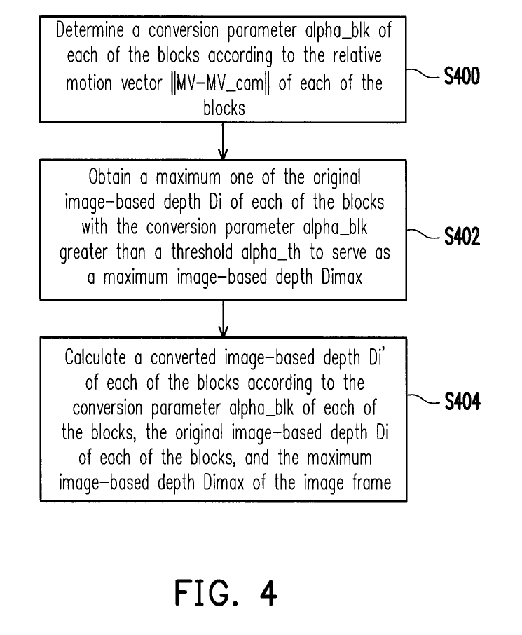

FIG. 4 is a flow chart of steps of a method for obtaining converted image-based depths Di′ according to an embodiment of the invention. Referring to FIG. 1 and FIG. 4, in this embodiment, during the procedure of converting the original image-based depth Di of each of the blocks into the converted image-based depths Di′, conversion parameters alpha_blk are used, and the conversion parameters alpha_blk may be generated according to a relative motion vector ∥MV−MV_cam∥ of each of the blocks.

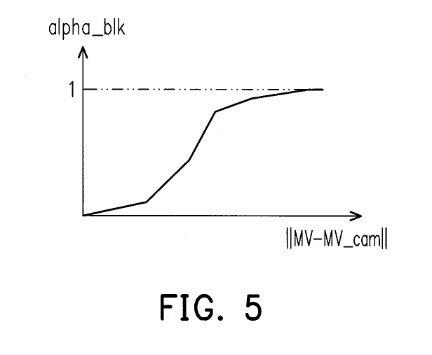

Specifically, in Step S400, the image-based depth conversion unit 124 first determines a conversion parameter alpha_blk of each of the blocks according to the relative motion vector ∥MV−MV_cam∥ of each of the blocks. FIG. 5 shows a curve mapping relationship between conversion parameters alpha_blk and relative motion vectors ∥MV−MV_cam∥ according to an embodiment of the invention. The image-based depth conversion unit 124 of this embodiment determines the conversion parameter alpha_blk of each of the blocks according to, for example, the curve mapping relationship shown in FIG. 5, but the invention is not limited to this. In other embodiments, the image-based depth conversion unit 124 may also determine the conversion parameter alpha_blk of each of the blocks by using a look-up table.

Then, in Step S402, the image-based depth conversion unit 124 obtains a maximum one of the original image-based depth Di of each of the blocks with the conversion parameters alpha_blk greater than a threshold alpha_th to serve as a maximum image-based depth Dimax. The threshold alpha_th is a fixed value, and may be set and adjusted according to design requirements.

Thereafter, in Step S404, the image-based depth conversion unit 124 may calculate a converted image-based depth Di′ of each of the blocks according to the original image-based depth Di of each of the blocks, the conversion parameter alpha_blk of each of the blocks obtained in Step S400, and the maximum image-based depth Dimax of the image frame obtained in Step S402. In an exemplary embodiment, in Step S404, the image-based depth conversion unit may calculate the converted image-based depths according to Formula 2 as follows:

Di′=alpha_blk*k*Dimax+(1−alpha_blk)*Di Formula 2,

where k is an adjustment parameter, and may be set as 0<k≦1.

It should be noted that, in the procedure of converting the image-based depths, the conversion parameters alpha_blk are determined by using the relative motion vectors ∥MV−MV_cam∥, and the maximum image-based depth Dimax is further selected, so the obtained converted image-based depths Di′ are compatible with the motion-based depths, that is, capable of matching the properties of the motion-based depths, thereby being fused to obtain the fusion depths Df with higher accuracy.

In view of the above, in the exemplary embodiments of the invention, the depth fusion method can be performed block by block, and after the original image-based depth of each of the blocks is converted, the converted image-based depths can be fused with the motion-based depth of each of the blocks, so as to obtain the fusion depth of each of the blocks. Moreover, in the procedure of obtaining the motion-based depths Dm, calculation can be performed by using differences between the local motion vectors and the global motion vector, that is, the relative motion vectors ∥MV−MV_cam∥, and when the global motion vector is calculated, the calculation of the central display region may be excluded, thereby avoiding the influence of the camera motion on the motion-based depths Dm. Further, in the procedure of converting the original image-based depths, the conversion parameters alpha_blk can be determined by using the relative motion vectors ∥MV−MV_cam∥, and the maximum image-based depth Dimax can be further selected, so the obtained image-based depths are compatible with the motion-based depths. As a result, the fusion of the obtained fusion depth of each of the blocks may be adjusted adaptively along with the moving object, and the depth in the region of the specific moving object can still keep the integrity thereof after the fusion without being split due to the depth fusion to cause the error of the image frame.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A depth fusion method, adapted for a 2D-to-3D conversion image processing apparatus, the depth fusion method comprising:
obtaining respective motion-based depths of a plurality of blocks in an image frame;
obtaining an original image-based depth of each of the blocks;
converting the original image-based depth of each of the blocks to obtain a converted image-based depth of each of the blocks; and
fusing, block by block, the motion-based depth and the converted image-based depth of each of the blocks to obtain a fusion depth of each of the blocks.

2. The depth fusion method according to claim 1, wherein the step of converting the original image-based depth of each of the blocks to obtain the converted image-based depth of each of the blocks is performed according to a difference between a local motion vector of each of the blocks and a global motion vector of the image frame.

3. The depth fusion method according to claim 1, wherein the step of obtaining the motion-based depths of the blocks comprises:
obtaining a local motion vector of each of the blocks;
calculating a global motion vector of the image frame according to the local motion vector of each of the blocks;
calculating a motion difference between the local motion vector of each of the blocks and the global motion vector, so as to generate a plurality of relative motion vectors; and
obtaining the motion-based depth of each of the blocks according to the relative motion vectors.

4. The depth fusion method according to claim 3, wherein the step of converting the original image-based depth of each of the blocks to obtain the converted image-based depth of each of the blocks comprises:
determining a conversion parameter of each of the blocks according to the relative motion vector of each of the blocks; and
using the conversion parameter of each of the blocks to convert the original image-based depth of the block into the converted image-based depth.

5. The depth fusion method according to claim 4, wherein the step of using the conversion parameter of each of the blocks to convert the original image-based depth of the block into the converted image-based depth comprises:
obtaining a maximum one of the original image-based depth of each of the blocks with the conversion parameter greater than a threshold to serve as a maximum image-based depth; and
calculating the converted image-based depth of each of the blocks according to the conversion parameter of each of the blocks, the original image-based depth of each of the blocks, and the maximum image-based depth of the image frame.

6. The depth fusion method according to claim 5, wherein Di′=alpha_blk* k*Dimax+(1−alpha_blk)*Di,
where Di is the original image-based depth, Di′ is the converted image-based depth, alpha_blk is the conversion parameter, k is an adjustment parameter, and 0<k≦1.

7. The depth fusion method according to claim 1, wherein the step of obtaining the original image-based depth of each of the blocks comprises:
determining the original image-based depth of each of the blocks according to image-based depth cues information of each of the blocks and consciousness-based depth cues information of the image frame.

8. A depth fusion apparatus, adapted for a 2D-to-3D conversion image processing apparatus, the depth fusion apparatus comprising:
a motion-based depth capture unit obtaining respective motion-based depths of a plurality of blocks in an image frame;
an image-based depth capture unit obtaining an original image-based depth of each of the blocks, and converting the original image-based depth of each of the blocks to obtain a converted image-based depth of each of the blocks; and
a depth fusion unit fusing, block by block, the motion-based depth and the converted image-based depth of each of the blocks to obtain a fusion depth of the blocks each of.

9. The depth fusion apparatus according to claim 8, wherein the image-based depth capture unit converts the original image-based depth of each of the blocks to obtain the converted image-based depth of each of the blocks according to a difference between a local motion vector of each of the blocks and a global motion vector of the image frame.

10. The depth fusion apparatus according to claim 8, wherein the motion-based depth capture unit comprises:
a motion estimation unit obtaining a local motion vector of each of the blocks, calculating a global motion vector of the image frame according to the local motion vector of each of the blocks, and calculating a motion difference between the local motion vector of each of the blocks and the global motion vector, so as to generate a plurality of relative motion vectors; and
a motion-based depth generation unit obtaining the motion-based depth of each of the blocks according to the relative motion vectors.

11. The depth fusion apparatus according to claim 9, wherein the image-based depth capture unit comprises:
an image-based depth conversion unit determining a conversion parameter of each of the blocks according to the relative motion vector of each of the blocks, and using the conversion parameter of each of the blocks to convert the original image-based depth of the block into the converted image-based depth.

12. The depth fusion apparatus according to claim 11, wherein the image-based depth conversion unit obtains a maximum one of the original image-based depth of each of the blocks with the conversion parameter greater than a threshold to serve as a maximum image-based depth, and calculates the converted image-based depth of each of the blocks according to the conversion parameter of each of the blocks, the original image-based depth of each of the blocks, and the maximum image-based depth of the image frame.

13. The depth fusion apparatus according to claim 12, wherein the image-based depth conversion unit calculates the converted image-based depth according to a formula as follows:
Di′=alpha_blk*k*Dimax+(1−alpha_blk)*Di,
where Di is the original image-based depth, Di′ is the converted image-based depth, alpha_blk is the conversion parameter, k is an adjustment parameter, and 0<k≦1.

14. The depth fusion apparatus according to claim 8, wherein the image-based depth capture unit comprises:
an image-based depth obtaining unit determining the original image-based depth of each of the blocks according to image-based depth cues information of each of the blocks and consciousness-based depth cues information of the image frame.
